(19) United States
(12) Patent Application Publication
(10) Pub. No.: US 2007/0261717 A1
(43) Pub. Date: Nov. 15, 2007

(54) Panel washing machine and washing method

(75) Inventor: Hitoshi Yoshida, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/797,546

(22) Filed: May 4, 2007

(30) Foreign Application Priority Data
May 8, 2006 (JP) 2006-129164

(51) Int. Cl. B08B 3/00; B08B 7/00

(52) U.S. Cl. 134/33; 134/198; 134/34; 134/137

(57) ABSTRACT

In a panel washing device for conveying a panel on a surface plate using an endless belt, spraying washing liquid from a wash nozzle, and washing and removing foreign substances from a surface of the panel by a washing head, a wash nozzle and water discharge path are disposed on a rear end part of a surface plate in a conveying direction of the panel in order to wash and remove the portion of the foreign substances removed from the surface of the panel that has accumulated on an inner surface of the endless belt. Accordingly, the foreign substances accumulated on the endless belt for conveying the panel are washed away and removed, and can be discharged to an exterior of the washing machine.

### BACKGROUND OF THE INVENTION

1. Field of the Invention

The present invention relates to a panel surface washing machine for washing away and removing dust, refuse, and other foreign substances attached to a surface of a glass substrate or the like used in, e.g., liquid crystal panels. In particular, the present invention relates to a panel washing machine and washing method suitable for preventing foreign substances from being transferred after washing to an endless belt for conveying a panel, and then once again soiling the panel.

2. Description of the Related Art

A liquid crystal panel is composed of a liquid crystal sealed between a pair of glass substrates. During the process for manufacturing the liquid crystal panel, foreign substances may adhere to surfaces of the glass substrates of the liquid crystal panel, which causes poor display quality in locations where the foreign substances are attached. For this reason, a step for removing foreign substances on the substrates must also be provided in the process for manufacturing the liquid crystal panel.

FIG. 1 is a cross-sectional diagram showing a structure of a conventional panel washing machine. The conventional panel washing machine comprises a surface plate 112 for supporting a panel 102; an endless travel device 109 and a conveyance roller 108 for conveying the panel 102; a wash nozzle 101 for spraying a washing liquid onto the panel 102; a washing head 103 for pressing a head against a surface of the panel and scanning the surface of the panel while rotating to wash the panel; and a panel washing liquid discharge channel 110 for discharging water to an exterior, as shown in FIG. 1.

The endless travel device 109 is composed of an endless belt 106 extended between a pair of rotating support rollers 107a and 107b that are disposed at a predetermined spacing. A panel 102 to be washed is mounted on the endless belt 106 via a support plate 105. The rotation support rollers 107a and 107b are rotatably driven, whereby the endless belt 106 and the panel 102 mounted on the endless belt are conveyed in a conveying direction shown in the drawing. A plurality of conveyance rollers 108 is provided on both sides of the endless travel device 109. The conveyance rollers 108 move the panel 102 from an upstream step toward the endless travel device 109, and then from the endless travel device 109 toward a downstream step. A plurality of suction holes 120 is provided to the endless belt 106. The surface plate 112 suctions and holds the panel 102 via the suction holes 120 during washing.

In a conventional panel washing machine having such a configuration, washing liquid is sprayed from the wash nozzle 101 toward the panel 102; the washing head 103 is pressed against the surface of the panel and passes over the surface thereof while rotating, whereby the surface of the panel 102 is washed; and foreign substances 104 attached to the surface of the panel 102 are washed away along with the washing liquid. The foreign substances 104 that are washed away and removed along with the washing liquid pass through the suction holes 120 as discharged water 111, and are discharged to the panel washing liquid discharge channel 110 provided below the endless belt 106.

Japanese Laid-open Patent Application Publication No. 2005-194060 illustrates an example of a panel conveyance device that differs from a panel washing machine, wherein a substrate conveyance device is disclosed. The substrate conveyance device has an endless belt and instances of foreign substances attaching to the substrate are minimized. Japanese Laid-open Patent Application Publication No. 2005-194060 illustrates an example of a panel conveyance device wherein a plurality of mounting member anchoring shafts that are disposed so that a length direction forms a right angle with the rotation direction of the endless belt is provided between the pair of endless belts that are disposed in parallel fashion; and a plurality of substrate mounting members is provided to the mounting member anchoring shafts. A substrate is supported in horizontal fashion on the substrate mounting members, and the mounting member anchoring shafts are moved horizontally in conjunction with the rotation of the endless belt, whereby the substrate is conveyed.

In Examined Patent Application Publication No. 8-1981, the disclosed prior art relates to a dust-preventing device for a substrate conveyance device provided to a washing line for washing a substrate. In the prior art, a washing mechanism for using a washing liquid to wash a drive gear of a drive part of a conveyance device for conveying a substrate, and a shower nozzle for spraying the substrate washing liquid toward the substrate, are provided in a processing layer for washing the substrate. In the washing mechanism of the drive gear, the washing liquid is supplied to a tray, the drive gear is held so as to be slightly submerged, the washing liquid is brought up from off the tray by the rotation of the drive part, and abrasion powder is washed away. A processing liquid guidance part for washing away dust on a bearing using some of the washing liquid sprayed from the shower nozzle and then discharging the dust to outside a frame anchoring the bearing is also provided in the vicinity of the rotation shaft provided to the conveyance device. Accordingly, the abrasion powder generated by the drive gear is washed away, and the abrasion powder generated by the bearing is washed away.

However, the following problems arise in the above-described prior art.

In the conventional panel washing machine shown in FIG. 1, the foreign substances that have entered into the endless travel device are discharged from the suction holes provided in the endless belt. However, the suction holes are small (having diameters of about 2 mm), and discharging is not readily performed. Therefore, the foreign substances accumulate/deposit in an inner part, whereby the foreign substances gradually accumulate. The deposited foreign substances that have adhered to the inner surface of the endless belt and remain between the surface plate and the endless belt form protuberances. For this reason, when the washing head is pressed against the surface of the panel during washing, the protuberances on the surface plate create a local pressure load on the panel, a spacer in the liquid crystal panel or the like is moved relative thereto, and defects occur in the panel display.

In addition, when the size of the suction holes is increased, suction power increases. Then, a local pressure load is generated by a concentrated load applied to the panel during washing as occurs with the protuberances, the spacer in the panel is moved relative to the liquid crystal panel or the like, and defects occur in the panel display.

Problems thus occur in a panel washing machine comprising the conventional endless travel device in that the mechanism for discharging foreign substances that have entered the endless travel device is inadequate. Moreover, a mechanism for washing an inner surface of the endless travel device is not provided, foreign substances accumulate in the endless travel device, and defects occur in the panel display.

### SUMMARY OF THE INVENTION

An object of the present invention is to provide a panel washing machine comprising a mechanism for washing away and removing foreign substances that have accumulated on an endless belt for conveying a panel and discharging the foreign substances to outside of the washing machine; and a washing method.

The panel washing machine according to the present invention comprises an endless belt for conveying a panel; a surface plate for supporting the conveyed panel from below an inner side of the endless belt; a washing device for washing the panel from above; and a wash nozzle for washing an inner surface of the endless belt.

The wash nozzle can spray a washing liquid onto an inner surface of the endless belt on a rear end part of the panel of the surface plate in the conveying direction.

The endless belt extends between a pair of rotation support rollers whose axes of rotation are horizontal, and conveys the panel in a movement area thereabove.

The wash nozzle preferably sprays a washing liquid from a front of a conveying direction of the panel to a rearward and diagonally upward direction onto an inner surface of the endless belt at a position of the rotation support roller on a rear part side in the conveying direction of the panel, the position being set apart from the endless belt.

A configuration may be adopted in which the endless belt has a plurality of through-holes; the surface plate has an air suction opening on an upper surface; and the panel is suctioned via the through-holes, and is thereby anchored to the surface plate. A configuration may also be adopted in which the endless belt is configured with a plurality of pairs of belts disposed parallel to one another; the surface plate has an air suction opening on an upper surface; and the panel is suctioned via gaps between the belts, and is thereby anchored to the surface plate.

The washing device may have a wash nozzle for supplying washing liquid to a surface of the panel; and a washing head for washing the surface of the panel by making contact with, and passing over the surface of, the panel.

A discharge member for collecting and discharging the washing liquid is preferably additionally provided.

In the panel washing method according to the present invention, a panel is conveyed on an endless belt, the panel is supported from below the endless belt by a surface plate, and the panel on the endless belt supported by the surface plate is washed from above by a washing device, wherein washing liquid is sprayed from a wash nozzle toward an inner surface of the endless belt on a rear end part of the panel of the surface plate in the conveying direction, thereby washing away foreign substances that have accumulated on the inner surface of the endless belt.

The endless belt preferably extends between a pair of rotation support rollers whose axes of rotation are horizontal, and conveys the panel in a movement area thereabove; and the wash nozzle preferably sprays a washing liquid from a front of a conveying direction of the panel in a rearward and diagonally upward direction onto an inner surface of the endless belt, at a position of the rotation support roller on a rear part side in the conveying direction of the panel, the position being set apart from the endless belt.

According to the present invention, the wash nozzle is provided to the rear end part of the surface plate in the conveying direction of the panel and the washing liquid is sprayed from the wash nozzle toward the inner surface of the endless belt, thereby removing the foreign substances that have accumulated on the inner surface of the endless belt. Accordingly, instances are prevented in which a pressure load is placed on the panel and the spacer in the panel is damaged or moved, whereby defects occur in the display.

### BRIEF DESCRIPTION OF THE DRAWINGS

FIG. 1 is a cross-sectional diagram showing a structure of a conventional panel washing machine;

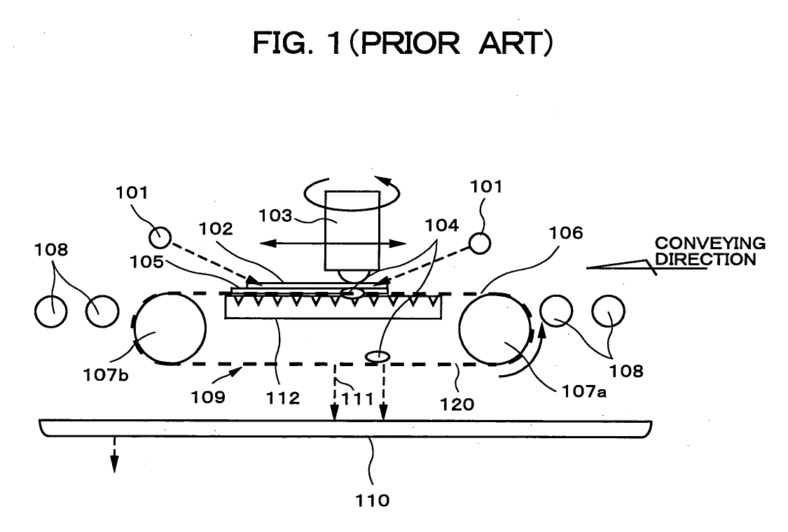

FIG. 2 is a cross-sectional diagram showing a panel washing machine according to a first embodiment of the present invention; and

FIG. 3 is a cross-sectional diagram showing a panel washing machine according to a second embodiment of the present invention.

### DESCRIPTION OF THE PREFERRED EMBODIMENTS

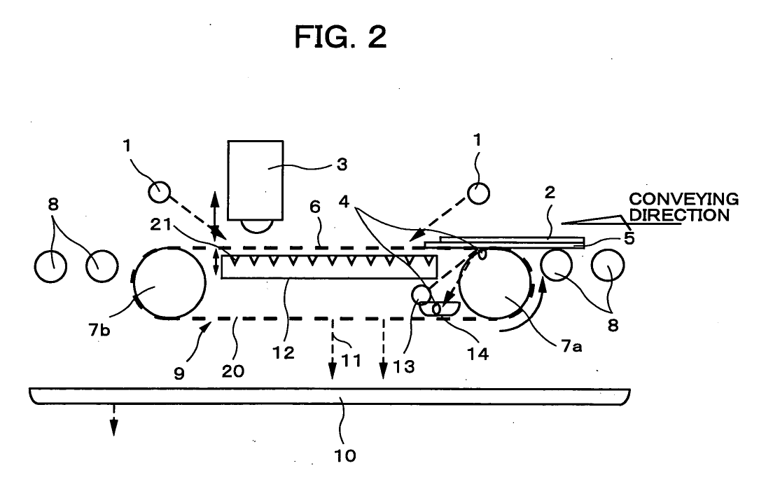

Embodiments of the present invention are described in detail below with reference to the accompanying drawings. First, a first embodiment of the present invention shall be described. FIG. 2 is a cross-sectional diagram showing a panel washing machine according to the first embodiment of the present invention.

As shown in FIG. 2, an endless travel device 9 having an endless belt 6 is provided in the panel washing machine of the present embodiment. In the endless travel device 9, the endless belt 6 spans a pair of rotation support rollers 7a and 7b disposed a predetermined distance apart so that their axes of rotation are horizontal and mutually parallel. At least one of the rotation support rollers 7a and 7b is rotatably driven by a suitable drive device, whereby the endless belt 6 is rotated in one direction. A plurality of conveyance rollers 8 for conveying a panel 2 into and out of the endless travel device 9 is provided to an entry side and an exit side of the endless belt 6 of the endless travel device 9. The conveyance rollers 8 are rotatably disposed so that the rotation axes thereof are perpendicular to the conveying direction of the panel. The panel 2 is supported by the conveyance rollers 8, and the rollers are rotated, whereby the panel is moved in a single direction. A plurality of suction holes 20 for suctioning the substrate is provided to the endless belt 6. The suction holes 20 are through-holes. As described below, the panel 2 is suctioned and held on a surface plate 12 via the suction holes 20 during washing.

The surface plate 12 for suctioning and holding the panel 2 during washing is provided in the vicinity of and below the endless belt 6 of an upper movement area. A plurality of air suction openings 21 is provided to an upper surface of the surface plate 12. The panel 2 to be washed, having been conveyed on the endless belt 6, is suctioned via the suction holes 20 of the endless belt 6, and the panel 2 is suctioned and anchored to the surface plate 12.

A wash nozzle 1 for spraying and supplying the washing liquid onto the panel 2 is provided above the endless belt 6 in the upper movement area. In the example shown in FIG. 2, two wash nozzles 1 are provided. The wash nozzles 1 spray the washing liquid toward the panel 2 from front and rear in the conveying direction. A washing head 3 is provided above the endless belt 6 in the upper movement area. The washing head 3 is pressed against the surface of the panel 2, passes over the panel 2 while rotating, and polishes and washes the surface of the panel 2. Meanwhile, a panel washing liquid discharge channel 10 for discharging the foreign substances 4 removed from the surface of the panel 2 along with the washing liquid is provided below the endless belt 6 of a lower movement area.

A wash nozzle 13 is provided in the vicinity of a rear end part of the surface plate 12 in the conveying direction of the panel 2. A water discharge channel 14 for discharging to the exterior of the washing machine the foreign substances 4 and washing liquid washed away and removed by spraying the washing liquid from the wash nozzle 13 is provided in the vicinity of the wash nozzle 13. The direction in which the washing liquid is sprayed from the wash nozzle 13 extends from a front of the panel conveying direction in a rearward and diagonally upward direction (a rightward and diagonally upward direction in the drawing), and faces an inner surface of the endless belt 6 at a position of the rotation support roller 7a that is set apart from the endless belt 6 and situated at a rear part in the conveying direction of the panel 2. The wash nozzle 13 preferably has a plurality of holes for spraying the washing liquid, and preferably sprays the washing liquid in an oblong slit form that is long in a width direction of the endless belt 6. All areas of the endless belt 6 in the width direction can thereby be washed by the single wash nozzle 13. Alternatively, a configuration may be adopted in which a plurality of wash nozzles is disposed in the width direction of the endless belt 6, and all areas of the endless belt 6 in the width direction are washed by the plurality of wash nozzles.

An operation of the present embodiment thus configured shall be described next. First, the panel provided on a support plate 5 is mounted, in accordance with the conveying direction of FIG. 2, on the endless belt 6 of the upper movement area via the conveyance roller 8 provided to the entrance of the endless belt 6 of the endless travel device 9, and is conveyed onto the surface plate 12 by the endless belt 6. The plurality of suction holes 20 (through-holes) is provided to the endless belt 6, and the plurality of air suction openings 21 is provided to the upper surface of the surface plate 12. Therefore, the panel 2 is suctioned from the air suction openings 21 of the surface plate 12 via the suction holes 20, whereby the panel 2 is suctioned and anchored to the surface plate 12. Next, water is sprayed as the washing liquid from the wash nozzle 1 onto the surface of the panel 2. The washing head 3 presses against the surface of the panel 2, rotates while supplying the water to the surface of the panel 2, and passes over the surface of the panel. The foreign substances 4 that are on the surface of the panel are washed away and removed.

The foreign substances 4 and washing liquid that are washed away and removed from the surface of the panel 2 pass through the suction holes 20 provided to the endless belt 6 of the upper movement area, and fall onto the endless belt 6 of the lower movement area. The foreign substances 4 and washing liquid then once again fall below the endless belt 6 from the suction holes 20 of the endless belt 6 of the lower movement area, collect as discharge water 11 in the panel washing liquid discharge channel 10, and are discharged. However, the suction holes 20 are small in size (e.g., are 2 mm in diameter). Therefore, the foreign substances 4 are not readily discharged, and a portion of the foreign substances 4 is not discharged to the exterior from the suction holes 20. Instead, this portion adheres to the inner surface of the endless belt 6.

The washed panel 2 is conveyed by the endless belt 6, carried out by the conveyance roller 8 provided to the exit side of the endless belt 6 of the endless travel device 9, and conveyed to the next step. When the panel is conveyed onto the surface plate before the next panel washing process, the washing liquid is ejected from the wash nozzle 13 toward the inner surface of the endless belt 6 at a position of the rotation support roller 7a set apart from the endless belt 6 at the same time that the endless belt 6 is rotated, and the foreign substances adhering to the inner surface of the endless belt 6 are washed away. More specifically, the washing liquid is sprayed from the wash nozzle 13 in a direction that is rearward and diagonally upward from a front of the panel conveying direction, and is sprayed toward the inner surface of the endless belt 6 at a position of the rotation support roller 7a set apart from the endless belt 6, whereby the foreign substances 4 adhering to the inner surface of the endless belt 6 are removed. The washing liquid sprayed from the wash nozzle 13 can be, e.g., in the form of a slit having a wide angle in the width direction of the endless belt 6. Thus, the direction in which the liquid is ejected is slightly to the rear of the conveying direction, and is therefore opposite a direction in which the foreign substances 4 conveyed along with the endless belt 6 move. The foreign substances 4 that have been washed off are then discharged along with the washing liquid to the exterior of the washing machine via the discharge channel 14.

An effect of the present embodiment shall be described next. The wash nozzle 13 and discharge channel 14 are disposed on a rear end part of the surface plate 12 in the conveying direction of the panel and the washing liquid is ejected from the wash nozzle 13 toward the inner surface of the endless belt 6 to wash the panel. The portion of the foreign substances 4 having been removed by washing the surface of the panel that has adhered to the endless belt 6 and has once again entered the space between the surface plate 12 and the panel 2 is thereby removed, and can be discharged along with the discharge water to the exterior of the washing machine via the discharge water channel 14. Accordingly, the rotation of the endless belt 6 prevents instances in which the foreign substances 4 accumulate on the surface plate 12, protuberances created by the foreign substances 4 place a local load on the panel to be washed, and local defects occur in the display in liquid display panel or other applications.

Providing the discharge water channel 14, via which the foreign substances 4 and discharge water removed by washing are discharged to the exterior of the washing machine, enables the washed-off foreign substances to be effectively discharged, and prevents accumulation of the foreign substances 4 adhering to the inner surface of the endless belt 6.

The wash nozzle 13 is disposed at the rear end part of the surface plate 12 in the conveying direction of the panel, whereby the foreign substances 4 adhering to the inner surface of the endless belt 6 can be removed before the endless belt 6 reaches the position at which the surface plate 12 is disposed. Instances can be prevented in which the foreign substances 4 reach the surface plate 12 and generate protuberances, a local load is applied to the panel, and local defects occur in the display. The washing liquid is sprayed from the wash nozzle 13 in a direction that is rearward and diagonally upward from a front of the panel conveying direction, whereby the washing liquid spraying direction and the movement direction of the foreign substances 4 are opposite one another. Therefore, the foreign substances 4 attached to the inner surface of the endless belt 6 can be effectively removed.

A configuration may also be adopted in which a plurality of belts is disposed in mutually parallel fashion as the endless belt 6. In this instance, the penetrating suction holes 20 need not be provided to the endless belt 6. The panel 2 is suctioned via the gaps between the belts and thereby suctioned and anchored to the surface plate 12.

In addition, the wash nozzle 13 for washing the inner surface of the endless belt is preferably provided to the rear end part of the surface plate 12 in the conveying direction of the panel. However, the wash nozzle can be provided at other locations to wash the inner surface of the endless belt 6.

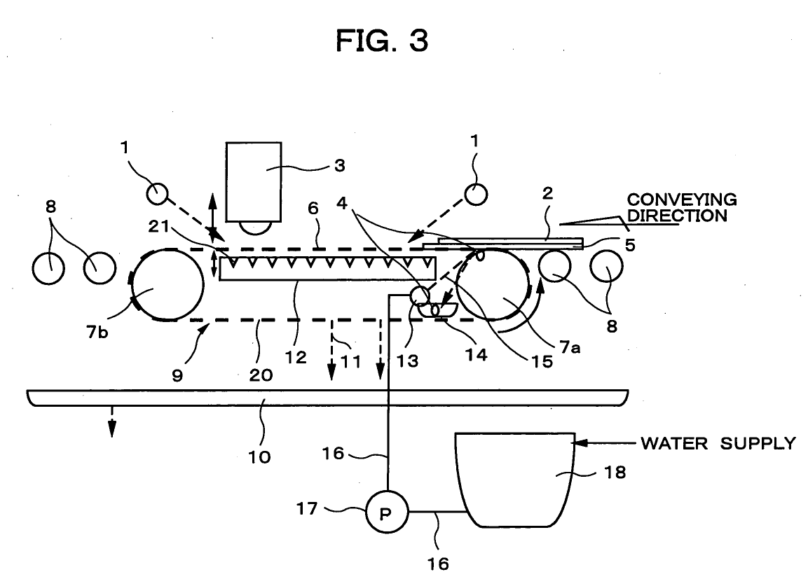

A second embodiment of the present invention shall be described next. FIG. 3 is a cross-sectional diagram showing a panel washing machine according to the second embodiment of the present invention.

The present embodiment differs from the first embodiment in that, in the present embodiment, high-pressure washing is performed using the wash nozzle 13 for washing the inner surface of the endless belt 6. The wash nozzle 13 is connected to a high-pressure pump 17 and water holding tank 18 via a supply pipe 16, as shown in FIG. 3. Accordingly, high-pressure water 15 can be ejected from the wash nozzle 13, the ability with which the inner surface of the endless belt 6 can be washed is increased, and the ability to remove foreign substances from the inner surface of the endless belt 6 can be increased. The configuration of the present embodiment is the same as that of the first embodiment in all other respects. For this reason, in FIG. 3, the same symbols mark the same component parts as in FIG. 2, and detailed descriptions thereof shall be omitted. In addition, other actions and effects of the present embodiment are the same as the actions and effects of the first embodiment.

The present invention can thus be suitably used to wash, e.g., a glass substrate for a liquid crystal panel.

What is claimed is:

1. A panel washing machine, comprising:
an endless belt for conveying a panel;
a surface plate for supporting said conveyed panel from below an inner side of said endless belt;
a washing device for washing said panel from above; and
a wash nozzle for washing an inner surface of said endless belt.

2. The panel washing machine according to claim 1, wherein said wash nozzle sprays a washing liquid onto an inner surface of said endless belt on a rear end part of said panel of said surface plate in the conveying direction.

3. The panel washing machine according to claim 1, wherein said endless belt extends between a pair of rotation support rollers whose axes of rotation are horizontal, and conveys said panel in a movement area thereabove.

4. The panel washing machine according to claim 2, wherein said endless belt extends between a pair of rotation support rollers whose axes of rotation are horizontal, and conveys said panel in a movement area thereabove.

5. The panel washing machine according to claim 1, wherein said wash nozzle sprays a washing liquid from a front of a conveying direction of said panel to a rearward and diagonally upward direction onto an inner surface of said endless belt at a position of the rotation support roller on a rear part side in the conveying direction of said panel, the position being set apart from said endless belt.

6. The panel washing machine according to claim 2, wherein said wash nozzle sprays a washing liquid from a front of a conveying direction of said panel to a rearward and diagonally upward direction onto an inner surface of said endless belt at a position of the rotation support roller on a rear part side in the conveying direction of said panel, the position being set apart from said endless belt.

7. The panel washing machine according to claim 1, wherein
said endless belt has a plurality of through-holes;
said surface plate has an air suction opening on an upper surface; and
said panel is suctioned via said through-holes, and is thereby anchored to said surface plate.

8. The panel washing machine according to claim 2, wherein
said endless belt has a plurality of through-holes;
said surface plate has an air suction opening on an upper surface; and
said panel is suctioned via said through-holes, and is thereby anchored to said surface plate.

9. The panel washing machine according to claim 1, wherein
said endless belt is configured with a plurality of pairs of belts disposed parallel to one another;
said surface plate has an air suction opening on an upper surface; and
said panel is suctioned via gaps between said belts, and is thereby anchored to said surface plate.

10. The panel washing machine according to claim 2, wherein
said endless belt is configured with a plurality of pairs of belts disposed parallel to one another;
said surface plate has an air suction opening on an upper surface; and
said panel is suctioned via gaps between said belts, and is thereby anchored to said surface plate.

11. The panel washing machine according to claim 1, wherein
said washing device has a wash nozzle for supplying washing liquid to a surface of said panel; and
a washing head for washing the surface of said panel by making contact with, and passing over the surface of, said panel.

12. The panel washing machine according to claim 2, wherein
said washing device has a wash nozzle for supplying washing liquid to a surface of said panel; and
a washing head for washing the surface of said panel by making contact with, and passing over the surface of, said panel.

13. The panel washing machine according to claim 1, further having a discharge member for collecting and discharging said washing liquid.

14. The panel washing machine according to claim 2, further having a discharge member for collecting and discharging said washing liquid.

15. A panel washing method in which a panel is conveyed on an endless belt, said panel is supported from below said endless belt by a surface plate, and said panel on said endless belt supported by said surface plate is washed from above by a washing device, wherein washing liquid is sprayed from a wash nozzle toward an inner surface of said endless belt on a rear end part of said panel of said surface plate in the conveying direction, thereby washing away foreign substances that have accumulated on the inner surface of said endless belt.

16. The panel washing method according to claim 15, wherein
said endless belt extends between a pair of rotation support rollers whose axes of rotation are horizontal, and conveys said panel in a movement area thereabove; and
said wash nozzle sprays a washing liquid from a front of a conveying direction of said panel in a rearward and diagonally upward direction onto an inner surface of said endless belt, at a position of the rotation support roller on a rear part side in the conveying direction of said panel, the position being set apart from said endless belt.
